(19) United States
(12) Patent Application Publication
(10) Pub. No.: US 2025/0286257 A1
(43) Pub. Date: Sep. 11, 2025

(54) SOLID-STATE SECONDARY BATTERY

(71) Applicant: HONDA MOTOR CO., LTD., Tokyo (JP)

(72) Inventors: Kizashi IWAKIRI, Saitama (JP); Takuya TANIUCHI, Saitama (JP); Toshimitsu TANAKA, Saitama (JP); Keisuke TSUTA, Saitama (JP); Tomohiko TSUZAKI, Saitama (JP)

(21) Appl. No.: 19/062,057

(22) Filed: Feb. 25, 2025

(30) Foreign Application Priority Data
Mar. 7, 2024 (JP) 2024-035150

(51) Int. Cl. H01M 50/593

(52) U.S. Cl. CPC H01M 50/593

(57) ABSTRACT

A solid-state secondary battery according to one embodiment of the present invention includes an electrode laminate that includes a positive electrode layer, a negative electrode layer, and a solid electrolyte layer placed between the positive electrode layer and the negative electrode layer, in which at least one of the negative electrode layer or the solid electrolyte layer includes a projection projecting from the positive electrode layer in a plan view, an insulating frame body placed on an outer periphery of the positive electrode layer, and an elastic body placed between the insulating frame body and the projection.

This application is based on and claims the benefit of priority from Japanese Patent Application No. 2024-035150, filed on 7 Mar. 2024, the content of which is incorporated herein by reference.

### BACKGROUND OF THE INVENTION

### Field of the Invention

The present invention relates to a solid-state secondary battery.

### Related Art

In recent years, research and development has been carried out on secondary batteries that contribute to energy efficiency in order for more people to be able to ensure access to energy that is reasonable, reliable, sustainable, and advanced. Among secondary batteries, solid-state secondary batteries including an electrode laminate in which a solid electrolyte layer is placed between a positive electrode layer and a negative electrode layer have particularly attracted attention since they are excellent in terms of improved safety thanks to non-flammable solid electrolytes and have higher energy density. In a solid-state secondary battery, an insulating frame body is placed around the positive electrode layer to prevent a positional deviation between the positive layer, the solid electrolyte layer, and the negative electrode layer in the electrode laminate and a short circuit in the electrode laminate, and the negative electrode layer is placed on the positive electrode layer surrounded by the insulating frame body via the solid electrolyte layer (Patent Document 1).
Patent Document 1: Japanese Unexamined Patent Application, Publication No. 2023-77228

### SUMMARY OF THE INVENTION

Incidentally, in the solid-state secondary battery, a challenge is to extend a lifetime thereof. It is effective to place an insulating frame body around the positive electrode layer in the solid-state secondary battery in order to extend the lifetime of the solid-state secondary battery. However, since it is difficult to maintain a constant basis weight of a positive electrode active material layer of the positive electrode layer when the positive electrode layer is industrially manufactured, there is a slight variation in thickness of the positive electrode layer. In addition, the solid electrolyte layer and the insulating frame body have roughness. Therefore, a gap may be generated between the solid electrolyte layer and the insulating frame body. To achieve a high capacity of the solid-state secondary battery, studies are underway to use lithium as a negative electrode active material. When the lithium is used as the negative electrode active material, a thickness of the negative electrode layer changes due to charge and discharge, and the solid electrolyte layer between the positive electrode layer and the negative electrode layer is deformed, which may cause a gap to be generated between the solid electrolyte layer and the insulating frame body. When a gap is generated between the solid electrolyte layer and the insulating frame body, the solid electrolyte layer may be deformed to lead to cause cracks due to pressure or impact from outside such as pressing at the time of manufacturing the solid-state secondary battery, restraint of the solid-state secondary battery, and vibration during transportation of the solid-state secondary battery. When a gap is generated between the solid electrolyte layer and the insulating frame body, foreign objects may enter side surfaces of the positive electrode layer.

The present invention has been made in view of the above-described circumstances, and an object thereof is to provide a solid-state secondary battery in which an insulating frame body can be stably placed around a positive electrode layer for a long period of time without generating a gap between the insulating frame body and a solid electrolyte layer. Consequently, the solid-state secondary battery contributes to energy efficiency.

The present inventors have found that the above-described problems can be solved by providing a projection projecting from a positive electrode layer in a plan view on at least one of a negative electrode layer or a solid electrolyte layer and placing an elastic body between the projection and an insulating frame body placed on an outer periphery of the positive electrode layer, thereby completing the present invention. Thus, the present invention provides the following aspects.

A first aspect of the present invention relates to a solid-state secondary battery including an electrode laminate that includes a positive electrode layer, a negative electrode layer, and a solid electrolyte layer placed between the positive electrode layer and the negative electrode layer, in which at least one of the negative electrode layer or the solid electrolyte layer includes a projection projecting from the positive electrode layer in a plan view, an insulating frame body placed on an outer periphery of the positive electrode layer, and an elastic body placed between the insulating frame body and the projection.

In the solid-state secondary battery of the first aspect, the elastic body is placed between the projection in the electrode laminate and the insulating frame body placed on the outer periphery of the positive electrode layer, and thus the insulating frame body can be stably insulated around the positive electrode layer for a long period of time without generating a gap between the insulating frame body and a solid electrolyte layer.

A second aspect of the present invention relates to the solid-state secondary battery described in the first aspect, in which a width-directional dimension of the elastic body is equal to or smaller than a width dimension of the insulating frame body.

In the solid-state secondary battery of the second aspect, the width-directional dimension of the elastic body is equal to or smaller than the width dimension of the insulating frame body, and thus the elastic body becomes unlikely to protrude to the outside beyond the insulating frame body even when a pressure is applied to the elastic body and the elastic body is deformed.

A third aspect of the present invention relates to the solid-state secondary battery described in the first or second aspect, in which the positive electrode layer includes a positive electrode current collector, and two positive electrode active material layers laminated on both surfaces of the positive electrode current collector, the negative electrode layer and the solid electrolyte layer are placed on opposite sides of the positive electrode layer to face each other, the projection includes at least two projections placed on opposite sides of the positive electrode layer to face each other, and the insulating frame body is placed between the projections placed to face each other.

In the solid-state secondary battery of the third aspect, the insulating frame body is placed between the projections placed on opposite sides of the positive electrode layer to face each other via the elastic body in the electrode laminate, and thus the side surfaces of the positive electrode layer can be insulated more stably.

A fourth aspect of the present invention relates to the solid-state secondary battery described in the first or second aspect, in which the positive electrode layer includes a positive electrode current collector, and a positive electrode active material layer laminated on one surface of the positive electrode current collector, the positive electrode current collector includes a projection projecting from the positive electrode active material layer in a plan view, and the insulating frame body is placed between the projection of the positive electrode current collector and the projection of at least one of the negative electrode layer or the solid electrolyte layer.

In the solid-state secondary battery of the fourth aspect, the insulating frame body is placed between the projections of the positive electrode current collector of the positive electrode layer and the projection of at least one of the negative electrode or the solid electrolyte layer via the elastic body, and thus the side surfaces of the positive electrode active material layer can be insulated more stably.

The present invention makes it possible to provide a solid-state secondary battery in which an insulating frame body can be stably placed around a positive electrode layer for a long period of time without generating a gap between the insulating frame body and a solid electrolyte layer.

### BRIEF DESCRIPTION OF THE DRAWINGS

FIG. 1 is a plan view illustrating a solid-state secondary battery according to one embodiment of the present invention;

FIG. 2 is a sectional view taken along line II-II of FIG. 1;

FIG. 3 is a sectional view taken along line III-III of

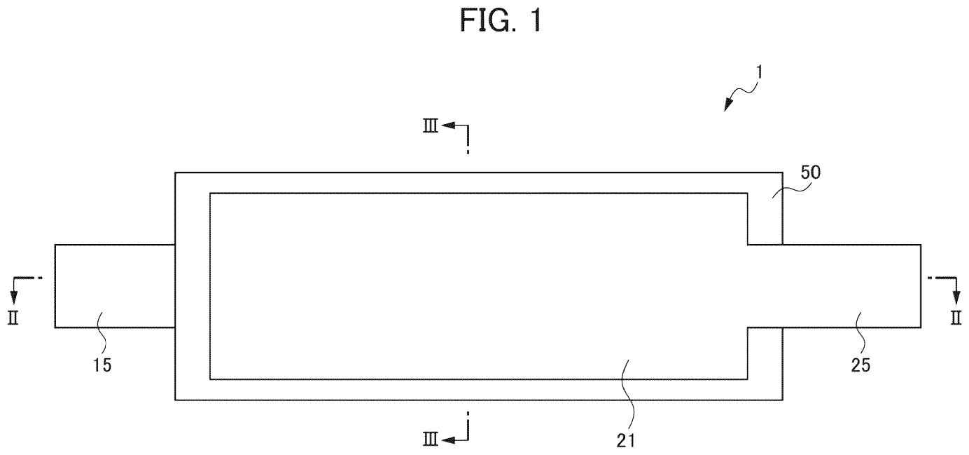

FIG. 1;

FIG. 4 is a sectional view of the solid-state secondary battery illustrated in FIG. 1 in a charged state;

FIG. 5 is a sectional view illustrating a method of manufacturing the solid-state secondary battery illustrated in FIG. 1;

FIG. 6 is a sectional view illustrating a solid-state secondary battery according to a first modified example of the present invention;

FIG. 7 is a sectional view of the solid-state secondary battery illustrated in FIG. 6 in a charged state; and

FIG. 8 is a sectional view illustrating a solid-state secondary battery according to a second modified example of the present invention.

### DETAILED DESCRIPTION OF THE INVENTION

Embodiments of the present invention will be described below with reference to the drawings. It should be noted, however, that the embodiments below are illustrative of the present invention, and the present invention is not limited to the following description.

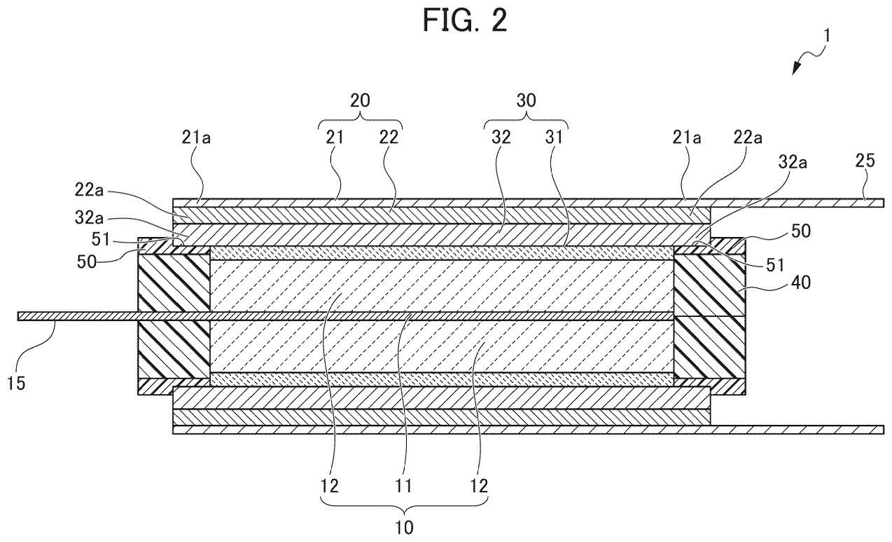

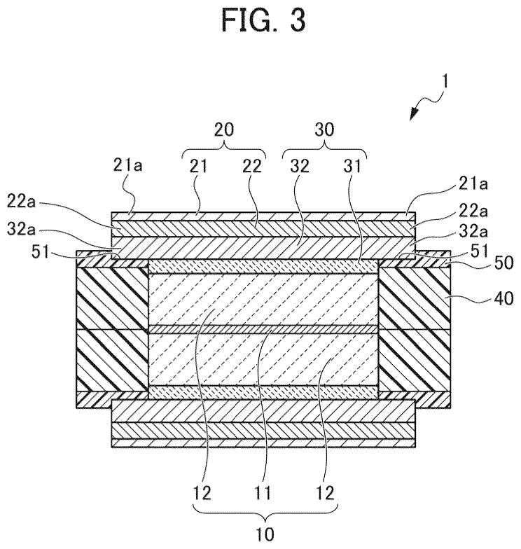

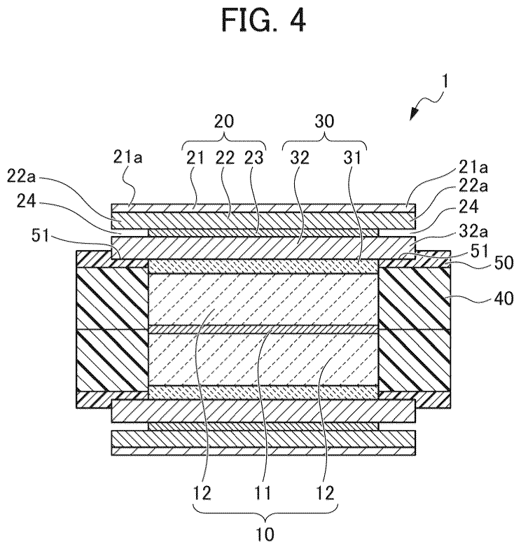

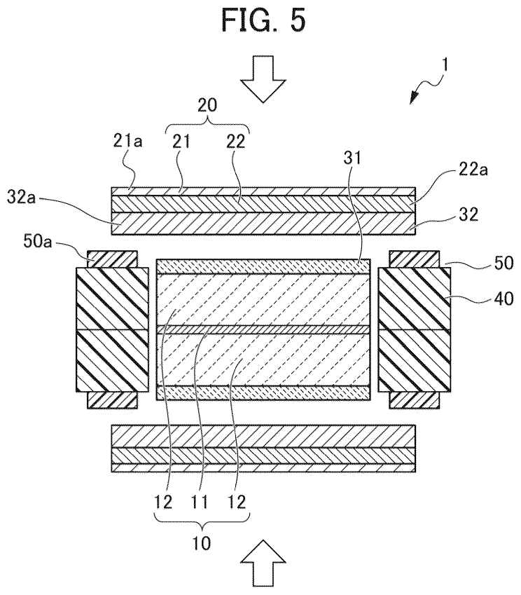

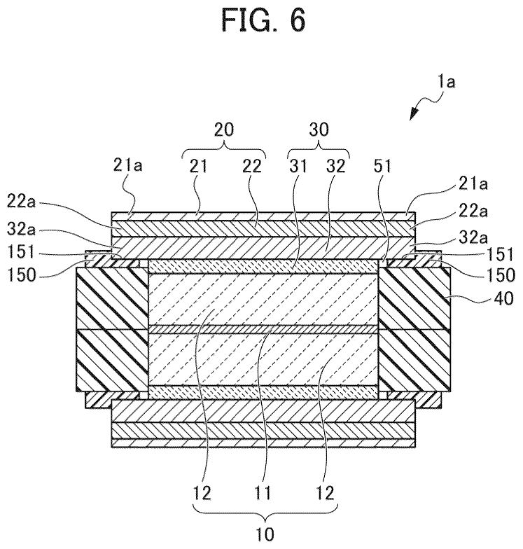

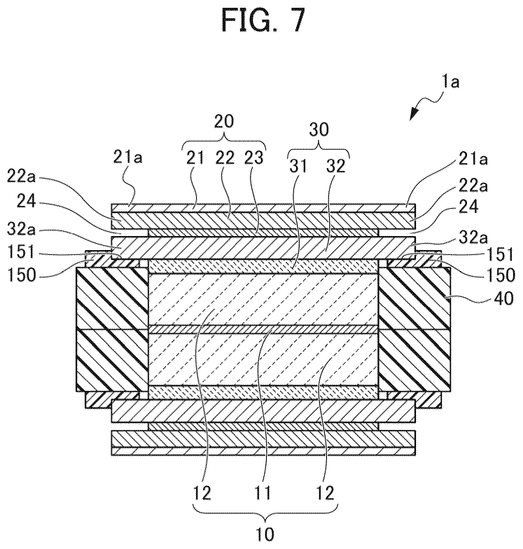

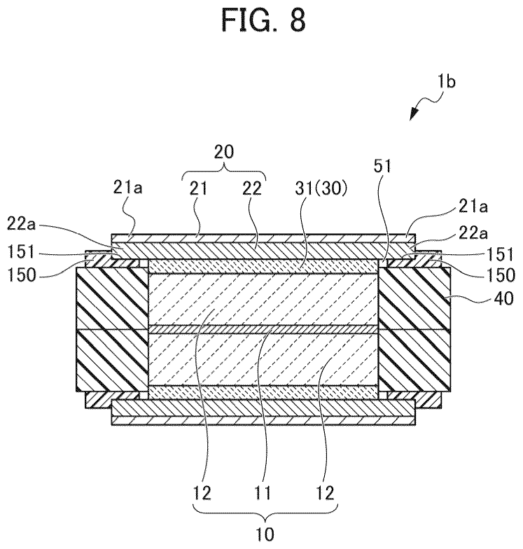

FIG. 1 is a plan view illustrating a solid-state secondary battery according to one embodiment of the present invention. FIG. 2 is a sectional view taken along line II-II of FIG. 1, and FIG. 3 is a sectional view taken along line III-III of FIG. 1. As illustrated in FIGS. 1 to 3, the solid-state secondary battery includes an electrode laminate 1, an insulating frame body 40, and an elastic body 50.

The electrode laminate 1 is a laminate including a positive electrode layer 10, a negative electrode layer 20, and a solid electrolyte layer 30 placed between the positive electrode layer 10 and the negative electrode layer 20. The positive electrode layer 10 includes a positive electrode current collector 11, and two positive electrode active material layers 12 laminated on respective surfaces of the positive electrode current collector 11. The negative electrode layer 20 and the solid electrolyte layer 30 are placed on opposite sides of the positive electrode layer 10 to face each other. Each of two negative electrode layers 20 facing each other includes a negative electrode current collector 21, and a metal layer 22 laminated on a surface on the solid electrolyte layer 30 side of the negative electrode current collector 21. The solid electrolyte layer 30 includes a first solid electrolyte layer 31 placed on the positive electrode layer 10 side, and a second solid electrolyte layer 32 placed on the negative electrode layer 20 side. The first solid electrolyte layer 31 has the same dimensions as the positive electrode layer 10 in a plan view. The second solid electrolyte layer 32 has a projection 32a projecting from the positive electrode layer 10 in a plan view. The projections 32a are placed on opposite sides of the positive electrode layer 10 to face each other. The dimensions of the negative electrode current collector 21 and the metal layer 22 are the same as the dimensions of the second solid electrolyte layer 32 in a plan view, and the negative electrode current collector 21 and the metal layer 22 have projections 21a and 22a, respectively. The insulating frame body 40 is placed between the projections 32a of the second solid electrolyte layers 32 placed to face each other. The elastic body 50 is placed between the insulating frame body 40 and the projection 32a of the second solid electrolyte layer 32. A portion of the elastic body 50 which is in contact with the second solid electrolyte layer 32 has a recess 51 formed by being pressed by the second solid electrolyte layer 32. The elastic body 50 is pressed by the second solid electrolyte layer 32 so that the recess 51 is formed, thereby making it difficult to generate a gap between the elastic body 50 and the solid electrolyte layer 32.

The electrode laminate 1 illustrated in FIGS. 1 to 3 is a discharged state. When the electrode laminate 1 is charged, lithium ions serving as charge transfer media released from the positive electrode active material layer 12 pass through the solid electrolyte layer 30, and are deposited on the surface of the metal layer 22 of the negative electrode layer 20 to generate a lithium deposited layer, resulting in an increase in thickness of the negative electrode layer 20. The lithium deposited layer serves as the negative electrode active material layer, and releases lithium ions during discharging. Therefore, in the electrode laminate 1, the thickness of the negative electrode layer 20 changes due to charge and discharge.

FIG. 4 is a sectional view of the solid-state secondary battery according to one embodiment of the present invention in a charged state. As illustrated in FIG. 4, in the electrode laminate 1 in a charged state, a lithium deposited layer 23 is generated on a surface of the metal layer 22 of the negative electrode layer 20, resulting in an increase in thickness of the negative electrode layer 20 in a portion facing the positive electrode layer 10. The lithium deposited layer 23 is generated, thereby causing a gap 24 to be generated between the projection 22a of the metal layer 22 and the projection 32a of the solid electrolyte layer 32.

The electrode laminate 1 is housed in an exterior housing body (not illustrated). The exterior housing body includes a positive electrode terminal to be connected to a positive electrode current collecting tab 15, and a negative electrode terminal to be connected to a negative electrode current collecting tab 25.

The positive electrode current collector 11 may have any material and shape as long as it has the function of collecting current from the positive electrode layer 10. Examples of the material of the positive electrode current collector 11 include aluminum, an aluminum alloy, stainless steel, nickel, iron, and titanium, and among them, aluminum, an aluminum alloy, and stainless steel are preferable. Examples of the shape of the positive electrode current collector 11 include a foil shape, and a plate shape.

The positive electrode active material layer 12 contains at least one type of positive electrode active material. The positive electrode active material is not limited to particular one, and a positive electrode active material which is used in the positive electrode layer in a general solid-state secondary battery can be used. Examples of the positive electrode active material which can be used include a lithium-containing layered active material, a spinel-type active material, and an olivine-type active material. Specific examples of the positive electrode active material include lithium cobalt oxide (LiCoO₂), lithium nickel oxide (LiNiO₂), LiNiₚMn_{g}COᵣO_{z} (p+q+r=1), LiNiₚAl_{q}COᵣO_{z} (p+q+r=1), lithium manganate (LiMn₂O₄), a different element substituted Li—Mn spinel represented by Li₁₊ₓMn_{2-x-y}Mo₄ (x+Y=2, M=at least one selected from Al, Mg, Co, Fe, Ni, and Zn), lithium titanate (oxide including Li and Ti), and lithium metal phosphate (LiMPO₄, M=at least one selected from Fe, Mn, Co and Ni).

In terms of enhancing the conductivity for lithium ions, the positive electrode active material layer 12 may optionally include a solid electrolyte. The positive electrode active material layer 12 may optionally include a conductive aid to enhance the conductivity. Furthermore, in terms of developing the flexibility, the positive electrode active material layer 12 may optionally include a binder. The solid electrolyte, the conductive aid, and the binder are not limited to particular ones, and a solid electrolyte, a conductive aid, and a binder which are used in the positive electrode layer in a general solid-state secondary battery can be used.

The positive electrode current collecting tab 15 may be made of the same material as the positive electrode current collector 11, or may be made of a material different from the positive electrode current collector 11. The positive electrode current collecting tab 15 may be integrally connected to the positive electrode current collector 11. In the present embodiment, the positive electrode current collecting tab 15 is formed as an extension of the positive electrode current collector 11, and is integrally connected to the positive electrode current collector 11.

The negative electrode current collector 21 may have any material and shape as long as it has the function of collecting current from the negative electrode layer 20. Examples of the material of the negative electrode current collector 21 include nickel, copper, and stainless steel. Examples of the shape of the negative electrode current collector 21 include a foil shape, and a plate shape.

The metal layer 22 may have any material and shape as long as it has the function of densely depositing lithium ions. As the metal layer 22, metallic lithium layer or a layer of metal which generates an alloy with lithium can be used. Examples of the metal which forms an alloy with lithium include Mg, Si, Au, Ag, In, Ge, Sn, Pb, Al, and Zn. The metal which forms the metal layer 22 may be in the shape of powder or may be in the shape of a thin film. The negative electrode layer 20 which includes this metal layer 22 is used, so that the lithium deposited layer can be uniformly generated on the surface of the metal layer 22.

The negative electrode current collecting tab 25 may be made of the same material as the negative electrode current collector 21, or may be made of a material different from the negative electrode current collector 21. The negative electrode current collecting tab 25 may be integrally connected to the negative electrode current collector 21. In the present embodiment, the negative electrode current collecting tab 25 is formed as an extension of the negative electrode current collector 21, and is integrally connected to the negative electrode current collector 21.

The thickness of the first solid electrolyte layer 31 of the solid electrolyte layer 30 may be either the same as or different from the thickness of the second solid electrolyte layer 32. The thickness of the second solid electrolyte layer 32 may be, for example, thicker than the thickness of the first solid electrolyte layer 31. The thickness of the second solid electrolyte layer 32 may fall, for example, within a range of 1 time or more and 100 times or less with respect to the thickness of the first solid electrolyte layer 31.

Each of the first solid electrolyte layer 31 and the second solid electrolyte layer 32 contains at least one type of solid electrolyte. Each of the first solid electrolyte layer 31 and the second solid electrolyte layer 32 conducts lithium ions

between the positive electrode layer 10 and the negative electrode layer 20 via the solid electrolyte. The first solid electrolyte layer 31 and the second solid electrolyte layer 32 may contain either the same solid electrolyte or a different solid electrolyte.

Although the solid electrolyte is not limited to particular one as long as it has the conductivity for lithium ions, examples of the solid electrolyte which can be used include a sulfide solid electrolyte, an oxide solid electrolyte, a nitride solid electrolyte, and a halide solid electrolyte.

Examples of the sulfide solid electrolyte include Li₂S—P₂S₅, and Li₂S—P₂S₅—LiI. The sulfide solid electrolyte may have an argyrodite type crystal structure.

Examples of the oxide solid electrolyte include a NASICON type oxide, a garnet type oxide, and a perovskite type oxide. Examples of the NASICON type oxide include oxides containing Li, Al, Ti, P, and O (for example, Li_{1.5}Al_{0.5}Ti_{1.5}(PO₄)₃). Examples of the garnet type oxide include oxides containing Li, La, Zr, and O (for example, Li₇La₃Zr₂O₁₂). Examples of the perovskite type oxide include oxides containing Li, La, Ti, and O (for example, LiLaTiO₃).

The solid electrolyte layer 30 may include a binder. The binder is not limited to particular one, and a binder which is used in the solid electrolyte layer in a general solid-state secondary battery can be used.

The solid electrolyte layer 30 may have an inner porous substrate. As the porous substrate, for example, a woven or nonwoven fabric can be used. The solid electrolyte having an inner porous substrate has high strength.

The insulating frame body 40 is placed to surround an outer periphery of the positive electrode layer 10. The insulating frame body 40 has electron insulating properties. The melting point of the insulating frame body 40 may be a temperature equal to or higher than the melting point of the lithium. The insulating frame body 40 preferably has chemical resistance. The insulating frame body 40 preferably has a shape stability higher than that of the elastic body 50. The insulating frame body 40 preferably has a Young's modulus higher than that of the elastic body 50, and a Poisson's ratio smaller than that of the elastic body 50. As the material of the insulating frame body 40, for example, resin, a ceramic material, or a mixture of resin and a ceramic material can be used. The resin includes rubber and elastomer. Examples of the resin include PET, PTFE, PI, PVdF, and SBR. The resin may be used alone or two or more thereof may be used in combination. The ceramic may be used alone or two or more thereof may be used in combination.

The elastic body 50 may be placed on the insulating frame body 40 in an unbonded state. The elastic body 50 may be easily deformed by being pressed by the second solid electrolyte layer 32 to such an extent that a recess 51 is formed. The Poisson's ratio of the elastic body 50 may fall, for example, within a range of 0.20 or more and 0.49 or less. The elastic body 50 may have any material as long as it has a Young's modulus lower than that the insulating frame body 40. As the material of the elastic body 50, the resin can be used. The resin is not limited to particular one as long as it is deformed more easily than the insulating frame body 40. The thickness of the elastic body 50 may be, for example, thicker than the thickness of the lithium deposited layer 23 that is generated during charging of the electrode laminate 1. The thickness of the elastic body 50 may fall, for example, within a range of 1 time or more and 100 times or less with respect to the thickness of the lithium deposited layer 23 that is generated during charging of the electrode laminate 1.

The exterior housing body 60 can be expanded and contracted as the thickness of the negative electrode layer 20 is changed due to charge and discharge. As the material of the exterior housing body 60, a laminate film can be used. As the laminate film, a laminate film having a three-layer structure can be used in which an inner resin layer, a metal layer, and an outer resin layer are laminated in this order from the inside. The outer resin layer may be, for example, a polyamide (nylon) layer, or a polyethylene terephthalate (PET) layer, the metal layer may be, for example, an aluminum layer, and the inner resin layer may be, for example, a polyethylene layer, or a polypropylene layer.

Next, a method of manufacturing the solid-state secondary battery in the present embodiment will be described. FIG. 5 is a sectional view illustrating a method of manufacturing the solid-state secondary battery according to one embodiment of the present invention. As illustrated in FIG. 5, the solid-state secondary battery can be manufactured as follows.

First, the first solid electrolyte layer 31 is laminated on each of upper and lower end surfaces of the positive electrode layer 10. Next, the insulating frame body 40 is placed around the positive electrode layer 10 in which the first solid electrolyte layers 31 are laminated, and the elastic body 50a is placed on each of upper and lower end surfaces of the insulating frame body 40. The elastic body 50 has a width dimension smaller than that of the insulating frame body 40. Next, the second solid electrolyte layer 32, the metal layer 22, and the negative electrode current collector 21 are laminated in this order on an end surface of the first solid electrolyte layer 31 laminated on each of the upper and lower end surfaces of the positive electrode layer 10.

Then, the obtained laminate is pressed in a laminating direction (arrow directions in FIG. 5). When the elastic body 50a is pressed by the projection 32a of the second solid electrolyte layer 32, the recess 51 is formed in the elastic body 50a, and the elastic body 50a spreads in the width direction, so that the elastic body 50a has the same width dimension as the insulating frame body 40 (see FIG. 3).

In the solid-state secondary battery in the present embodiment configured as described above, the insulating frame body 40 is placed between the projections 32a of the second solid electrolyte layers 32 placed on opposite sides of the positive electrode layer 10 in the electrode laminate 1 to face each other via the respective elastic bodies 50, and thus side surfaces of the positive electrode layer 10 can be stably insulated.

In the solid-state secondary battery in the present embodiment, in a plan view, the insulating frame body 40 and the elastic body 50 have the largest outer diameter, the negative electrode layer 20 and the second solid electrolyte layer 32 have the next largest outer diameter, and the positive electrode layer 10 and the first solid electrolyte layer 31 have the smallest outer diameter. The insulating frame body 40 has an outer diameter larger than that of the second solid electrolyte layer 32, and the second solid electrolyte layer 32 does not project from the insulating frame body 40, thereby making it possible to suppress cracks in the second solid electrolyte layers 32 and prevent impurities from entering the periphery of the positive electrode layer 10 due to the cracks in the second solid electrolyte layers 32. The elastic body 50 has an outer diameter larger than that of the second solid electrolyte layer 32, thereby making it possible to form the recess 51 in the elastic body 50 when the elastic body 50 is pressed by the second solid electrolyte layer 32, and to ensure an insulating function by the elastic body 50.

In the solid-state secondary battery in the present embodiment, the position of the upper end surface of the first solid electrolyte layer 31 is set to be higher than the position of the upper end surface of the insulating frame body 40, and the position of the upper end surface of the elastic body 50 is set to be higher than the position of the upper end surface of the first solid electrolyte layer 31. The position of the upper end surface of the elastic body 50 is set to be higher than the position of the upper end surface of the first solid electrolyte layer 31, thereby making it possible to form the recess 51 in the elastic body 50 when the elastic body 50 is pressed by the second solid electrolyte layer 32, and to ensure an insulating function by the elastic body 50.

Although in the present embodiment, a width-directional dimension of the elastic body 50 is the same as the width dimension of the insulating frame body 40, the width-directional dimension of the elastic body 50 may be smaller than the width dimension of the insulating frame body 40. With reference to FIGS. 6 and 7, a solid-state secondary battery in a first modified example will be described in which a width-directional dimension of the elastic body 50 is smaller than a width dimension of the insulating frame body 40.

FIG. 6 is a sectional view illustrating the solid-state secondary battery according to the first modified example, and FIG. 7 is a sectional view of the solid-state secondary battery in a charged state. The solid-state secondary battery in the first modified example is the same as the solid-state secondary battery illustrated in FIGS. 1 to 5, except that a width-directional dimension of an elastic body 150 placed on an outer periphery of a positive electrode layer 10 in an electrode laminate 1a is smaller than a width dimension of an insulating frame body 40. Therefore, the other components are designated by the same reference numerals as used in FIGS. 1 to 5, and duplicate description thereof will be omitted.

As illustrated in FIG. 6, in the solid-state secondary battery in the first modified example, the elastic body 150 is placed between a projection 32a of a second solid electrolyte layer 32 and the insulating frame body 40 in the electrode laminate 1a. The width-directional dimension of the elastic body 150 is smaller than the width dimension of the insulating frame body 40. The elastic body 150 is pressed by the projection 32a of the second solid electrolyte layer 32, so that a recess 151 is formed. As illustrated in FIG. 7, in the electrode laminate 1a in a charged state, a lithium deposited layer 23 is generated on a surface of a metal layer 22 of the negative electrode layer 20, resulting in an increase in thickness of the negative electrode layer 20 in a portion facing a positive electrode layer 10.

In the solid-state secondary battery in the first modified example, the elastic body 150 is pressed by the projection 32a of the second solid electrolyte layer 32, and thus side surfaces of a positive electrode layer 10 can be stably insulated, similarly to the effect of the solid-state secondary battery described above. Furthermore, in the solid-state secondary battery in the first modified example, the width-directional dimension of the elastic body 150 is smaller than the width dimension of the insulating frame body 40, and a volume of an outer portion of the elastic body 150 can be reduced, which can enhance the volume energy density.

Although in the present embodiment, the solid electrolyte layer 30 has a two-layer structure of the first solid electrolyte layer 31 and the second solid electrolyte layer 32, the solid electrolyte layer 30 may include any one of the first solid electrolyte layer 31 and the second solid electrolyte layer 32. With reference to FIG. 8, a solid-state secondary battery in a second modified example will be described in which only a first solid electrolyte layer 31 is used as a solid electrolyte layer 30.

FIG. 8 is a sectional view illustrating the solid-state secondary battery according to the second modified example. The solid-state secondary battery in the second modified example is similar to the solid-state secondary battery in the first modified example illustrated in FIG. 6, except that the solid electrolyte layer 30 is a single layer of only the first solid electrolyte layer 31. Therefore, the other components are designated by the same reference numerals as used in FIG. 6, and duplicate description thereof will be omitted.

In the solid-state secondary battery in the second modified example illustrated in FIG. 8, the solid electrolyte layer 30 in an electrode laminate 1b includes only the first solid electrolyte layer 31. An elastic body 150 is pressed by a projection 22a of a metal layer 22, so that a recess 151 is formed. The position of the upper end surface of the first solid electrolyte layer 31 is set to be higher than the position of the upper end surface of an insulating frame body 40, and the position of the upper end surface of an elastic body 50 is set to be higher than the position of the upper end surface of the first solid electrolyte layer 31.

In the solid-state secondary battery in the second modified example, the elastic body 150 is pressed by the projection 22a of the metal layer 22 of the negative electrode layer 20, and thus side surfaces of a positive electrode layer 10 can be stably insulated, similarly to the effect of the solid-state secondary battery described above. Furthermore, in the solid-state secondary battery in the second modified example, the thickness of the solid electrolyte layer 30 can be reduced and a volume of the electrode laminate 1b can be reduced, which can enhance the volume energy density.

Although the embodiments of the present invention have been described above, the present invention is not limited to the embodiments described above. For example, although in the present embodiment, the electrode laminate 1 is a laminate including the positive electrode layer 10, the negative electrode layer 20, and the solid electrolyte layer 30 placed between the positive electrode layer 10 and the negative electrode layer 20, a configuration of the electrode laminate 1 is not limited thereto. An intermediate layer may be provided between the negative electrode layer 20 and the solid electrolyte layer 30. The intermediate layer includes a material having the conductivity for the lithium ions and a material having the electron conductivity, and may be a layer having the electron conductivity and having pores through which lithium ions can pass. As the material having the conductivity for the lithium ions, for example, amorphous carbon particles can be used. As the material having the electron conductivity, for example, metal particles can be used.

Although in the present embodiment, the negative electrode layer 20 includes the metal layer 22, the metal layer 22 may be omitted so that the lithium can be deposited on the surface of the negative electrode current collector 21. Instead of the metal layer 22, a layer may be used which includes a negative electrode active material capable of absorbing and releasing lithium ions. Examples of the negative electrode active material include lithium transition metal oxides such as lithium titanate, transition metal oxides such as TiO₂, Nb₂O₃, and WOn, Si, SiO, metal sulfides, metal nitrides, and carbon materials such as artificial graphite, natural graphite, graphite, soft carbon and hard carbon. In terms of enhancing the conductivity for the lithium ions, the negative electrode active material layer may optionally include a solid electrolyte. The negative electrode active material layer may optionally include a conductive aid to enhance the conductivity. Furthermore, in terms of developing the flexibility, the negative electrode active material layer may optionally include a binder. As the solid electrolyte, the conductive aid and the binder, a solid electrolyte, a conductive aid, and a binder which are used in a general solid-state secondary battery can be used.

Although in the present embodiment, the positive electrode layer 10 is provided in which the positive electrode active material layer 12 is laminated on each surface of the positive electrode current collector 11, the positive electrode active material layer 12 may be laminated only on one surface of the positive electrode current collector 11. In a case where the positive electrode active material layer 12 is laminated only on one surface of the positive electrode current collector 11, the positive electrode current collector 11 of the positive electrode layer 10 may be provided with a projection projecting from the positive electrode active material layer 12 in a plan view so that the insulating frame body 40 is placed between the projection of the positive electrode current collector 11 and the projection of at least one of the negative electrode layer 20 or the solid electrolyte layer 30 via the elastic body 50. The elastic body 50 is pressed by the projection of the positive electrode current collector 11 and the projection of one of the negative electrode layer 20 and the solid electrolyte layer 30 thereby making it possible to stably insulate the side surfaces of the positive electrode active material layer 12.

### EXPLANATION OF REFERENCE NUMERALS

1 electrode laminate
10 positive electrode layer
11 positive electrode current collector
12 positive electrode active material layer
15 positive electrode current collecting tab
20 negative electrode layer
21 negative electrode current collector
21a projection
22 metal layer
22a projection
23 lithium deposited layer
24 gap
25 negative electrode current collecting tab
30 solid electrolyte layer
31 first solid electrolyte layer
32 second solid electrolyte layer
32a projection
40 insulating frame body
50, 50a, 150 elastic body
51, 151 recess

What is claimed is:

1. A solid-state secondary battery, comprising:
an electrode laminate that includes a positive electrode layer, a negative electrode layer, and a solid electrolyte layer placed between the positive electrode layer and the negative electrode layer, wherein at least one of the negative electrode layer or the solid electrolyte layer includes a projection projecting from the positive electrode layer in a plan view;
an insulating frame body placed on an outer periphery of the positive electrode layer; and
an elastic body placed between the insulating frame body and the projection.

2. The solid-state secondary battery according to claim 1, wherein a width-directional dimension of the elastic body is equal to or smaller than a width dimension of the insulating frame body.

3. The solid-state secondary battery according to claim 1, wherein
the positive electrode layer includes a positive electrode current collector, and two positive electrode active material layers laminated on both surfaces of the positive electrode current collector,
the negative electrode layer and the solid electrolyte layer are placed on opposite sides of the positive electrode layer to face each other,
the projection includes at least two projections placed on opposite sides of the positive electrode layer to face each other, and
the insulating frame body is placed between the projections placed to face each other.

4. The solid-state secondary battery according to claim 1, wherein
the positive electrode layer includes a positive electrode current collector, and a positive electrode active material layer laminated on one surface of the positive electrode current collector,
the positive electrode current collector includes a projection projecting from the positive electrode active material layer in a plan view, and
the insulating frame body is placed between the projection of the positive electrode current collector and the projection of at least one of the negative electrode layer or the solid electrolyte layer.
